(19) United States
(12) Patent Application Publication
(10) Pub. No.: US 2026/0011725 A1
(43) Pub. Date: Jan. 8, 2026

(54) CATHODE FOR LITHIUM SECONDARY BATTERY AND LITHIUM SECONDARY BATTERY INCLUDING THE SAME

(71) Applicant: SK ON CO., LTD., Seoul (KR)

(72) Inventors: Hyeon Soo KANG, Daejeon (KR); Jae Ram KIM, Daejeon (KR); Ji Won NA, Daejeon (KR); So Hyun PARK, Daejeon (KR); Sang Won BAE, Daejeon (KR); Ji Hee BAE, Daejeon (KR); Yeon Hwa SONG, Daejeon (KR); Ki Joo EOM, Daejeon (KR); Jeong Seok YEON, Daejeon (KR); Geon Hee YOON, Daejeon (KR); Myung Ro LEE, Daejeon (KR); Jae Yeong LEE, Daejeon (KR); Hyun Joong JANG, Daejeon (KR); Hye Ju JANG, Daejeon (KR)

(21) Appl. No.: 19/258,899

(22) Filed: Jul. 3, 2025

(30) Foreign Application Priority Data
Jul. 5, 2024 (KR) 10-2024-0088878

(51) Int. Cl. H01M 4/525; H01M 4/02; H01M 4/36; H01M 10/052

(52) U.S. Cl. CPC H01M 4/525; H01M 4/366; H01M 10/052; H01M 2004/021; H01M 2004/028

(57) ABSTRACT

A cathode for a lithium secondary battery according to the present disclosure includes: a cathode current collector; a first cathode active material layer disposed on at least one surface of the cathode current collector and including first lithium metal oxide particles having a secondary particle structure; and a second cathode active material layer disposed on the first cathode active material layer and including second lithium metal oxide particles having a single particle structure. Each of the first cathode active material layer and the second cathode active material layer includes pores. A ratio of the median pore diameter (D50) of the first cathode active material layer to that of the second cathode active material layer is 2.5 to 4.

### CROSS-REFERENCE TO RELATED APPLICATION

This patent application claims the priority and benefits of Korean patent application No. 10-2024-0088878, filed on Jul. 5, 2024, the disclosure of which is incorporated herein by reference in its entirety.

### BACKGROUND OF THE INVENTION

### 1. Field of the Invention

The present disclosure relates to a cathode for a lithium secondary battery, and a lithium secondary battery including the same.

### 2. Description of the Related Art

A secondary battery is a battery that can be repeatedly charged and discharged. With the rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design, such that development thereof is progressing in this regard.

The lithium secondary battery may include, for example, an electrode assembly including a cathode, an anode and a separation membrane (separator) interposed between the cathode and the anode, and an electrolyte that impregnates the electrode assembly.

The cathode may include a cathode current collector and a cathode active material layer formed on the cathode current collector. For example, the cathode active material layer may include lithium metal oxide particles as a cathode active material.

In general, the lithium metal oxide particles may have the form of secondary particles in which a plurality of primary particles are aggregated.

Meanwhile, cracks may be generated in the particles due to intercalation and deintercalation of lithium during repeated charging and discharging of the lithium secondary battery.

Accordingly, problems such as gas generation due to side reactions between the lithium metal oxide particles and an electrolyte, degradation in cycle life characteristics of the lithium secondary battery, and the like may occur. In addition, the above-described problems may be further intensified in high-temperature environments.

### SUMMARY OF THE INVENTION

An object of the present disclosure is to provide a cathode for a lithium secondary battery having improved electrochemical properties.

Another object of the present disclosure is to provide a lithium secondary battery including the cathode.

A cathode for a lithium secondary battery according to exemplary embodiments of the present disclosure includes: a cathode current collector; a first cathode active material layer disposed on at least one surface of the cathode current collector and including first lithium metal oxide particles having a secondary particle structure; and a second cathode active material layer disposed on the first cathode active material layer and including second lithium metal oxide particles having a single particle structure. Each of the first cathode active material layer and the second cathode active material layer includes pores. A ratio of a median pore diameter (D50) of the first cathode active material layer to that of the second cathode active material layer is 2.5 to 4.

According to exemplary embodiments, a ratio of a porosity of the first cathode active material layer to that of the second cathode active material layer may be greater than 1 and less than or equal to 5.

According to exemplary embodiments, the first cathode active material layer may have a median pore diameter (D50) of 10 μm to 20 μm.

According to exemplary embodiments, the second cathode active material layer may have a median pore diameter (D50) of 3 μm to 6 μm.

According to exemplary embodiments, the first cathode active material layer may have a porosity of 10% to 40%.

According to exemplary embodiments, the second cathode active material layer may have a porosity of 5% to 30%.

According to exemplary embodiments, each of the first cathode active material layer and the second cathode active material layer may independently have an areal density of 3 mg/cm² to 30 mg/cm².

According to exemplary embodiments, each of the first cathode active material layer and the second cathode active material layer may independently have a thickness of 10 μm to 100 μm.

According to exemplary embodiments, a ratio of the density (g/cm³) of the first cathode active material layer to that of the second cathode active material layer may be 0.3 to 1.1.

According to exemplary embodiments, the first lithium metal oxide particles may have a median particle diameter (D50) of 10 μm to 30 μm.

According to exemplary embodiments, the second lithium metal oxide particles may have a median particle diameter (D50) of 1 μm to 10 μm.

According to exemplary embodiments, each of the first lithium metal oxide particles and the second lithium metal oxide particles may include nickel, and a mole fraction of nickel based on the total number of moles of elements excluding lithium and oxygen in the first lithium metal oxide particles and the second lithium metal oxide particles may be 60 mol % to 99 mol %.

A lithium secondary battery according to exemplary embodiments of the present disclosure includes: the cathode for a lithium secondary battery; and an anode disposed opposite to the cathode.

According to exemplary embodiments of the present disclosure, the active material layer adjacent to the separation membrane of the cathode for a lithium secondary battery may include a cathode active material having a high strength. Accordingly, deterioration of the crystal structure occurring at the cathode-separation membrane interface during high-rate charging of the battery may be prevented.

By preventing side reactions between the cathode for a lithium secondary battery according to exemplary embodiments of the present disclosure and the electrolyte, the amount of gas generated at high temperatures may be reduced. Accordingly, the high-temperature storage characteristics of the battery may be improved.

The fast-charging characteristics, high-temperature cycle life characteristics, and high-temperature storage characteristics of the lithium secondary battery according to exemplary embodiments of the present disclosure may be improved.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view of a cathode for a lithium secondary battery according to an embodiment;

FIG. 2 is a plan view of a lithium secondary battery according to an embodiment; and

FIG. 3 is a schematic cross-sectional view of the lithium secondary battery according to an embodiment.

### DETAILED DESCRIPTION OF THE INVENTION

A cathode for a lithium secondary battery according to an exemplary embodiment of the present disclosure includes a cathode active material layer having a multi-layer structure. In addition, a lithium secondary battery according to an exemplary embodiment of the present disclosure includes the cathode.

Hereinafter, the present disclosure will be described in detail through embodiments with reference to the accompanying drawings. However, the embodiments are merely illustrative and the present disclosure is not limited to the specific embodiments described by way of example.

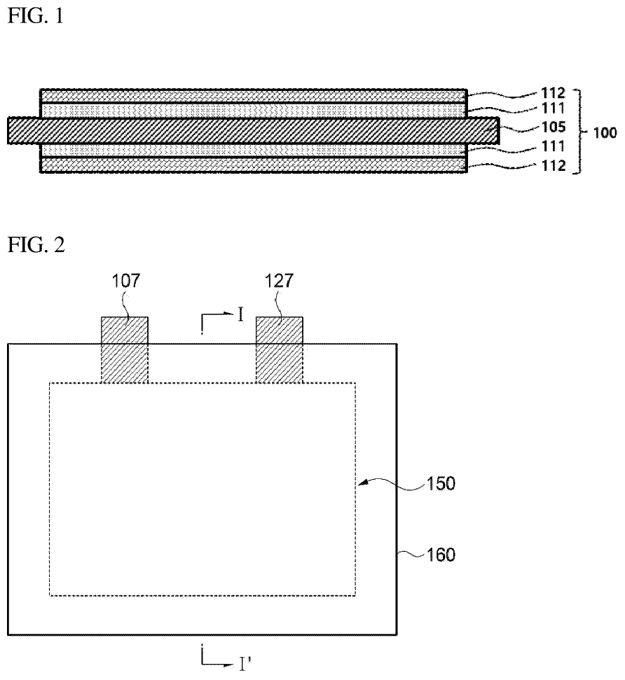

FIG. 1 is a schematic cross-sectional view of a cathode for a lithium secondary battery (hereinafter, also abbreviated as a ‘cathode’) according to an embodiment.

Referring to FIG. 1, a cathode 100 for a lithium secondary battery may include a cathode current collector 105 and a cathode active material layer disposed on at least one surface of the cathode current collector 105. The cathode active material layer may include a first cathode active material layer 111 and a second cathode active material layer 112, wherein the first cathode active material layer 111 and the second cathode active material layer 112 may be sequentially laminated on at least one surface of the cathode current collector 105.

According to exemplary embodiments, the first cathode active material layer 111 may be formed directly on the surface of the cathode current collector 105. The second cathode active material layer 112 may be formed directly on an upper surface (e.g., a surface opposite to the contact surface with the cathode current collector) of the first cathode active material layer 111.

The first cathode active material layer 111 includes first lithium metal oxide particles, and the second cathode active material layer 112 includes second lithium metal oxide particles. The first cathode active material layer 111 and the second cathode active material layer 112 may include different lithium metal oxides as the cathode active material, thereby improving the cycle life characteristics of the cathode.

The first lithium metal oxide particles have a secondary particle structure, and the second lithium metal oxide particles have a single particle structure. The secondary particles and the single particles may be distinguished based on the morphology of the particles.

For example, the structures of the secondary particles and the single particles may be identified based on cross-sectional images of the particles obtained using a scanning electron microscope (SEM).

The secondary particle may refer to a particle in which a plurality of primary particles are aggregated and observed or regarded as substantially one particle. For example, the secondary particles may be aggregated with greater than 10, 30 or more, 50 or more, or 100 or more primary particles.

The single particle may refer to a monolithic particle having a structure distinct from the secondary particle. However, the single particle does not exclude a form in which fine particles (e.g., particles having a volume of 1/100 or less relative to the volume of the single particle) are attached to the particle surface or a form in which 10 or less primary particles are aggregated.

For example, in the second cathode active material layer 112, the single particles may be in contact with each other. The form in which the single particles are in contact with each other and the form of the secondary particles may be distinguishable and may be identified through SEM images. For example, 2 to 10 single particles may be in contact with each other.

The particles are not distinguished based on crystallographic characteristics. Accordingly, the primary particles and the single particles may be single-crystalline or polycrystalline in terms of crystallography.

The second lithium metal oxide particles having a single particle structure may have high particle strength, thereby reducing the likelihood of particle cracking and deterioration of the crystal structure during repeated charging and discharging of the battery. Accordingly, side reactions on the surface of the second cathode active material layer 112, which is disposed apart from the current collector 105 and may be in direct contact with the electrolyte and/or the separation membrane, may be prevented, and the cycle life characteristics of the cathode may be improved.

According to exemplary embodiments, the first lithium metal oxide particles may have a median particle diameter (D50) of 10 μm to 30 μm. According to some embodiments, the first lithium metal oxide particles may have a median particle diameter (D50) of 15 μm to 25 μm. Within the above range, a cathode having high capacity and improved stability may be implemented.

According to exemplary embodiments, the second lithium metal oxide particles may have a median particle diameter (D50) of 1 μm to 10 μm. According to some embodiments, the second lithium metal oxide particles may have a median particle diameter (D50) of 3 μm to 7 μm. Within the above range, a cathode having enhanced durability and cycle life stability may be implemented.

According to exemplary embodiments, a ratio of the median particle diameter (D50) of the first lithium metal oxide particles to that of the second lithium metal oxide particles may be 1.5 to 3. Within the above range, a cathode having enhanced durability and stability may be implemented.

As used herein, the “median particle diameter (D50) of the particles” refers to a particle diameter at a point where the cumulative volume distribution percentage of the particles reaches 50%. The cumulative volume distribution may be obtained, for example, using a laser particle size analyzer (e.g., Malvern Mastersize 3000).

The first lithium metal oxide particles and the second lithium metal oxide particles may include nickel (Ni), and may further include at least one of cobalt (Co) and manganese (Mn).

According to exemplary embodiments, a mole fraction of nickel based on the total number of moles of elements excluding lithium and oxygen in the first lithium metal oxide particles and the second lithium metal oxide particles may each be 60 mol % to 99 mol %. The nickel contents of the first lithium metal oxide particles and the second lithium metal oxide particles may be the same or different. In some embodiments, the nickel content of the first lithium metal oxide particles may be greater than that of the second lithium metal oxide particles.

Each of the first lithium metal oxide particles and the second lithium metal oxide particles may independently include a layered structure represented by Formula 1 below.

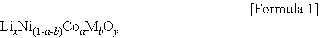

For example, in Formula 1, M may be at least one of Al, Zr, Ti, Cr, B, Mg, Mn, Ba, Si, Y, W and Sr, and x, y, a and b may satisfy 0.9≤x≤1.2, 1.9≤y≤2.1, 0≤a+b≤0.5.

In some embodiments, a and b may satisfy 0<a+b≤0.4, 0<a+b≤0.3, 0<a+b≤0.2, 0<a+b≤0.17,0<a+b≤0.15,0<a+b≤0.12, or 0<a+b≤0.1.

In some embodiments, a may satisfy 0<a≤0.1, 0<a≤0.08, or 0<a≤0.05.

As indicated in Formula 1, the lithium metal compound may include Ni among Ni, Co and M in the greatest amount or molar ratio. Ni may function as a metal substantially related to the output and/or capacity of the lithium secondary battery, and by including Ni in the greatest amount among transition metals, a high-capacity, high-output lithium secondary battery may be implemented.

When the content of Ni in the cathode active material or lithium metal oxide increases, the chemical stability such as the high-temperature storage stability of the secondary battery, may be relatively degraded. In addition, sufficient high-output and high-capacity characteristics resulting from the high Ni content may not be implemented due to surface damage on the cathode active material or side reactions with the electrolyte during repeated charge/discharge cycles.

In one embodiment, the lithium metal oxide particles may further include a coating element or a doping element. For example, the coating element or doping element may include Al, Ti, Ba, Zr, Si, B, Mg, P, Sr, W, La or an alloy or oxide thereof. In this case, a lithium secondary battery with improved cycle life characteristics may be implemented.

The first cathode active material layer includes pores formed by gaps between the first lithium metal oxide particles, and the second cathode active material layer includes pores formed by gaps between the second lithium metal oxide particles. The electrolyte may penetrate into the pores and interact with the cathode active material to enable intercalation and deintercalation of lithium ions.

A ratio of the median pore diameter (D50) of the first cathode active material layer to that of the second cathode active material layer is 2.5 to 4. According to exemplary embodiments, the ratio may be 2.7 to 3.8, or 3 to 3.5.

Within the above range, the cycle life characteristics and high-temperature storage characteristics of the cathode may be improved, as well as a high-capacity battery may be implemented.

When the ratio of the median pore diameter (D50) of the first cathode active material layer to that of the second cathode active material layer is less than 2.5, the difference in pore diameters between the first cathode active material layer and the second cathode active material layer may be insufficient, which may result in less effective prevention of side reactions with the electrolyte.

When the ratio of the median pore diameter (D50) of the first cathode active material layer to that of the second cathode active material layer exceeds 4, the content of lithium metal oxide in the first cathode active material layer may decrease, which may result in a reduction in cathode capacity.

In the present specification, the “median pore diameter (D50)” may be measured based on the internal pore morphology obtained by imaging the cathode active material layer using an X-ray microscope (XRM).

For example, two-dimensional images of the cathode active material layer may be captured in the thickness direction using an X-ray microscope under the following conditions.
Angular step: 1/2400
3D pixel size (voxel): 350 nm
X-ray source: 60 kV, 5 W

Next, the two-dimensional images may be rendered into a three-dimensional structure using application software (e.g., Geodict software from Marth2Market) to obtain a three-dimensional structure image having the internal pore morphology of the cathode active material layer. A porosity analysis of the cathode active material layer may be performed based on the three-dimensional structure image. In the three-dimensional structure image, an empty space in which a sphere with a specific diameter can exist may be defined as the pore diameter.

By measuring the pore diameter values included in the three-dimensional structure image, the median pore diameter (D50) may be defined as a value represented by (Dₘᵢₙ+Dₘₐₓ)/2, where Dₘᵢₙ is the minimum value and Dₘₐₓ is the maximum value of the pore diameter values.

In addition, the porosity of the cathode active material layer may be calculated from the three-dimensional structure image. For example, a ratio of the cumulative volume of all pores to the total volume of the three-dimensional structure image may be defined as the porosity of the cathode active material layer.

For example, the Xradia 520 Versa, manufactured by Zeiss, may be used as the X-ray microscope.

According to exemplary embodiments, the first cathode active material layer may have a median pore diameter (D50) of 10 μm to 20 μm. According to some embodiments, the first cathode active material layer may have a median pore diameter (D50) of 12 μm to 18 μm, or 13 μm to 16 μm.

According to exemplary embodiments, the second cathode active material layer may have a median pore diameter (D50) of 3 μm to 6 μm. According to some embodiments, the second cathode active material layer may have a median pore diameter (D50) of 3.5 μm to 5.5 μm, or 4 μm to 5 μm.

Within the above range, the cycle life characteristics and high-temperature storage characteristics of the cathode may be further improved.

According to exemplary embodiments, a ratio of the porosity of the first cathode active material layer to that of the second cathode active material layer may be greater than 1 and less than or equal to 5. According to some embodiments, the ratio of the porosity of the first cathode active material layer to that of the second cathode active material layer may be greater than 1 and less than or equal to 4, 3, or 2.

According to exemplary embodiments, the first cathode active material layer may have a porosity of 10% to 40%. According to some embodiments, the first cathode active material layer may have a porosity of 15% to 35%, or 20% to 30%.

According to exemplary embodiments, the second cathode active material layer may have a porosity of 5% to 30%. According to some embodiments, the second cathode active material layer may have a porosity of 10% to 25%, or 10% to 20%.

Within the above range, the cycle life characteristics and high-temperature storage characteristics of the cathode may be further enhanced.

According to exemplary embodiments, a ratio of the areal density (loading amount, in units of mg/cm²) of the first cathode active material layer to that of the second cathode active material layer may be 1 to 3. According to some embodiments, the ratio of the areal density of the first cathode active material layer to that of the second cathode active material layer may be 1.5 to 2.5. Within the above range, the high-temperature cycle life characteristics of the high capacity cathode may be enhanced.

According to exemplary embodiments, the first cathode active material layer may have an areal density of 3 mg/cm² to 30 mg/cm². According to some embodiments, the first cathode active material layer may have an areal density of 5 mg/cm² to 20 mg/cm², or 7 mg/cm² to 12 mg/cm².

According to exemplary embodiments, the second cathode active material layer may have an areal density of 3 mg/cm² to 30 mg/cm². According to some embodiments, the second cathode active material layer may have an areal density of 5 mg/cm² to 20 mg/cm², or 12 mg/cm² to 18 mg/cm².

According to exemplary embodiments, the first cathode active material layer may have a thickness of 10 μm to 100 μm. According to some embodiments, the first cathode active material layer may have a thickness of 15 μm to 70 μm, or 20 μm to 40 μm.

According to exemplary embodiments, the second cathode active material layer may have a thickness of 10 μm to 100 μm. According to some embodiments, the second cathode active material layer may have a thickness of 15 μm to 70 μm, or 30 μm to 50 μm.

According to exemplary embodiments, the first cathode active material layer may have a density (g/cm³) of 1 g/cm³ to 20 g/cm³. According to some embodiments, the first cathode active material layer may have a density (g/cm³) of 1.5 g/cm³ to 10 g/cm³, or 2 g/cm³ to 4.5 g/cm³.

According to exemplary embodiments, the second cathode active material layer may have a density (g/cm³) of 1 g/cm³ to 20 g/cm³. According to some embodiments, the second cathode active material layer may have a density (g/cm³) of 1.5 g/cm³ to 10 g/cm³, or 2 g/cm³ to 4.5 g/cm³.

The densities of the first cathode active material layer and the second cathode active material layer may be calculated by dividing the areal density of each layer by its thickness.

According to exemplary embodiments, a ratio of the density (g/cm³) of the first cathode active material layer to that of the second cathode active material layer may be 0.3 to 1.1. According to some embodiments, the ratio of the density (g/cm³) of the first cathode active material layer to that of the second cathode active material layer may be 0.5 to 1. Within the above range, the high-temperature cycle life characteristics of the high-capacity cathode may be improved.

According to exemplary embodiments, the first cathode active material layer and the second cathode active material layer may be formed by applying a slurry including the first lithium metal oxide particles or the second lithium metal oxide particles to the surface of the cathode current collector, followed by drying and compression.

For example, a slurry may be prepared by mixing the first lithium metal oxide particles or the second lithium metal oxide particles with a binder, a conductive material, and/or a dispersant in a solvent, followed by stirring. The cathode current collector 105 may be coated with the slurry, then dried and roll-pressed to prepare the cathode 100.

The cathode current collector 105 may include, for example, stainless steel, nickel, aluminum, titanium, copper, or an alloy thereof, and preferably includes aluminum or an aluminum alloy.

The binder may include, for example, an organic binder such as vinylidene fluoride-hexafluoropropylene copolymer (PVDF-co-HFP), polyvinylidene fluoride (PVDF), polyacrylonitrile, polymethyl methacrylate, etc., or aqueous binder such as styrene-butadiene rubber (SBR), and may be used together with a thickener such as carboxymethyl cellulose (CMC).

For example, a PVDF-based binder may be used as the cathode binder. In this case, an amount of the binder for forming the cathode active material layer may be reduced and an amount of the cathode active material may be relatively increased, thereby improving the output and capacity of the secondary battery.

The conductive material may be included to promote electron migration between the active material particles. For example, the conductive material may include carbon-based conductive materials such as graphite, carbon black, graphene, or carbon nanotubes and/or metal-based conductive materials, including perovskite materials, such as tin, tin oxide, titanium oxide, LaSrCoO₃, and LaSrMnO₃, etc.

The lithium secondary battery according to exemplary embodiments may include the above-described cathode, an anode disposed opposite to the cathode, a separation membrane interposed between the cathode and the anode, and an electrolyte.

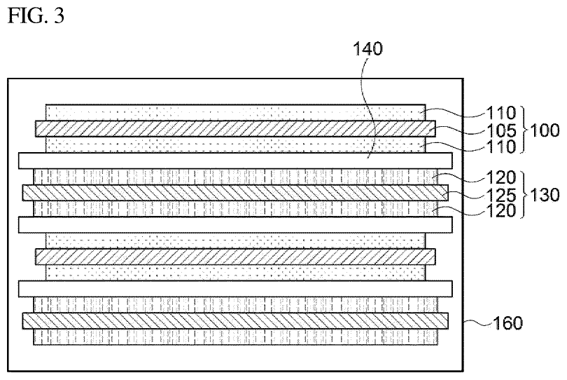

Hereinafter, the lithium secondary battery according to exemplary embodiments will be described in more detail with reference to the drawings. FIGS. 2 and 3 are schematic plan and cross-sectional views illustrating the lithium secondary battery according to exemplary embodiments, respectively. For example, FIG. 3 is a cross-sectional view taken along the line I-I′ of FIG. 2 in the thickness direction.

Referring to FIG. 2 and FIG. 3, the lithium secondary battery may include an electrode assembly including the cathode 100, the anode 130, and a separation membrane 140 interposed between the cathode and the anode. The electrode assembly may be accommodated in a case 160 together with an electrolyte and may be impregnated with the electrolyte.

The cathode 100 includes the cathode current collector 105 and the cathode active material layer 110, wherein the cathode active material layer 110 includes a first cathode active material layer and a second cathode active material layer (not shown). The cathode 100 may be the same as described above.

The anode 130 may include an anode current collector 125, and an anode active material layer 120 formed by coating an anode active material onto the anode current collector 125. If necessary, the anode may include an anode binder and a conductive material.

The anode active material usable herein may include any material known in the related art, as long as it can intercalate and deintercalate lithium ions, without particular limitation thereof. For example, carbon-based materials such as crystalline carbon, amorphous carbon, carbon composite, carbon fiber, etc.; a lithium alloy; a silicon (Si) compound or tin, etc. may be used. Examples of the amorphous carbon may include hard carbon, cokes, mesocarbon microbead (MCMB), mesophase pitch-based carbon fiber (MPCF) or the like.

Examples of the crystalline carbon may include graphite-based carbon such as natural graphite, artificial graphite, graphite cokes, graphite MCMB, graphite MPCF or the like. Other elements included in the lithium alloy may include, for example, aluminum, zinc, bismuth, cadmium, antimony, silicon, lead, tin, gallium or indium, etc.

The silicon compound may include, for example, silicon, silicon oxide or a silicon-carbon composite compound such as silicon carbide (SiC).

For example, when the anode active material includes the silicon-based active material, there may be a problem in that a thickness of the battery is increased during repeated charging and discharging. The lithium secondary battery according to exemplary embodiments may include the above-described electrolyte to relieve a thickness increase rate of the battery.

In some embodiments, the content of the silicon-based active material in the anode active material may be 1 to 20 wt %, 1 to 15 wt %, or 1 to 10 wt %.

For example, a slurry may be prepared by mixing the anode active material with a binder, a conductive material and/or a dispersant in a solvent, followed by stirring. The anode current collector 125 may be coated with the slurry, then dried and compressed to prepare the anode active material layer 120.

For example, an anode slurry may be prepared by mixing the anode active material with the above-described components in a solvent. The anode slurry may be applied or deposited on the anode current collector, then dried and roll-pressed to prepare the anode active material layer 120. The coating process may be performed using methods such as gravure coating, slot die coating, simultaneous multilayer die coating, imprinting, doctor blade coating, dip coating, bar coating or casting, etc., but it is not limited thereto. The anode active material layer 120 may further include a binder and optionally further include a conductive material, a thickener, etc.

Non-limiting examples of the solvent may include water, pure water, deionized water, distilled water, ethanol, isopropanol, methanol, acetone, n-propanol, t-butanol, etc.

The above-described materials that can be used when manufacturing the cathode as the binder, conductive material and thickener may also be used for the anode.

In some embodiments, a styrene-butadiene rubber (SBR)-based binder, carboxymethyl cellulose (CMC), polyacrylic acid-based binder, poly(3,4-ethylenedioxythiophene) (PEDOT)-based binder, and the like may be used as an anode binder.

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

In some embodiments, the anode 130 may have an area (e.g., a contact area with the separation membrane 140) and/or volume larger than those/that of the cathode 100. Thereby, lithium ions generated from the cathode 100 may smoothly migrate to the anode 130 without being precipitated during the process, for example.

According to exemplary embodiments, an electrode cell is defined by the cathode 100, the anode 130 and the separation membrane 140, and a plurality of electrode cells are stacked to form, for example, a jelly roll type electrode assembly 150. For example, the electrode assembly 150 may be formed by winding, laminating, or folding the separation membrane 140.

The electrode assembly 150 may be accommodated in the case 160 together with the non-aqueous electrolyte according to the above-described exemplary embodiments to define the lithium secondary battery. According to exemplary embodiments, the non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻,SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and the like may be used. These compounds may be used alone or in combination of two or more thereof.

As illustrated in FIG. 2, electrode tabs (a cathode tab and an anode tab) protrude from the cathode current collector 105 and the anode current collector 125, respectively, which belong to each electrode cell, and may extend to one side of the outer case 160. The electrode tabs may be fused together with the one side of the outer case 160 to form electrode leads (a cathode lead 107 and an anode lead 127) that extend or are exposed to the outside of the outer case 160.

The lithium secondary battery may be manufactured, for example, in a cylindrical shape using a can, a prismatic shape, a pouch shape or a coin shape.

Hereinafter, embodiments of the present invention will be further described with reference to specific experimental examples. However, the following examples and comparative examples included in the experimental examples are only given for illustrating the present invention and those skilled in the art will obviously understand that various alterations and modifications are possible within the scope and spirit of the present invention. Such alterations and modifications are duly included in the appended claims.

### Example 1

### Preparation of Cathode Active Material

NiSO₄, CoSO₄, and MnSO₄ were mixed in a ratio of 75:5:20 using distilled water from which dissolved oxygen had been removed by bubbling it with N₂ for 24 hours. The mixed solution was introduced into a reactor at 50° C., and NaOH as a precipitant and NH₃·H₂O as a chelating agent were added thereto. A co-precipitation was performed for 48 hours to obtain Ni_{0.75}Co_{0.05}Mn_{0.2}(OH)₂ as a transition metal precursor. The obtained precursor was dried at 80° C. for 12 hours and then further dried at 110° C. for an additional 12 hours.

Lithium hydroxide and the transition metal precursor were added to a dry high-speed mixer in a ratio of 1.01:1 to 1.025:1 and uniformly mixed for 5 minutes. The mixture was introduced into a calcination furnace, heated to 730° C. to 750° C. at a heating rate of 2° C./min, and maintained at 730° C. to 750° C. for 10 hours to calcine. Oxygen was continuously supplied at a flow rate of 10 mL/min during the heating and calcination. After completion of the calcination, the resulting product was naturally cooled to room temperature, then pulverized and classified to obtain first lithium metal oxide particles having a secondary particle structure of LiNi_{0.75}Co_{0.05}Mn_{0.2}O₂ (D₅₀: 15 μm).

Lithium hydroxide and the transition metal precursor were added to a dry high-speed mixer in a ratio of 1.01:1 to 1.025:1 and uniformly mixed for 5 minutes. The mixture was introduced into a calcination furnace, heated to 930° C. to 950° C. at a heating rate of 2° C./min, and maintained at 930° C. to 950° C. for 10 hours to calcine. Oxygen was continuously supplied at a flow rate of 10 mL/min during the heating and calcination. After completion of the calcination, the resulting product was naturally cooled to room temperature, then pulverized and classified to obtain second lithium metal oxide particles having a single particle structure of LiNi_{0.75}Co_{0.05}Mn_{0.2}O₂ (D₅₀: 5 μm).

### Fabrication of Cathode

The first lithium metal oxide particles, a binder (PVdF), and a conductive material (Super P) were mixed in a mass ratio of 96:2:2 to prepare a first cathode slurry. Then, a second cathode slurry was prepared in the same manner, except that the second lithium metal oxide particles were used instead of the first lithium metal oxide particles.

The first cathode slurry was uniformly applied onto an aluminum foil (thickness: 12 μm), then dried and roll-pressed to form a first cathode active material layer having an areal density of 12 mg/cm² and a thickness of 35 μm.

The second cathode slurry was uniformly applied onto the first cathode active material layer, then dried and roll-pressed to form a second cathode active material layer having an areal density of 12 mg/cm² and a thickness of 35 μm.

### Manufacture of Lithium Secondary Battery

Artificial graphite and natural graphite as anode active materials, styrene-butadiene rubber as a binder, and carboxymethyl cellulose as a thickener were mixed in a weight ratio of 96:2:2, and then the mixture was dispersed in water to prepare an anode active material slurry. A copper foil having a thickness of 8 μm was coated with the slurry, then dried and roll-pressed to prepare an anode.

A film separator made of polyethylene (PE) material with a thickness of 13 μm was stacked between the prepared electrodes, and a cell was assembled using a pouch having dimensions of 5 mm (thickness)×50 mm (width)×60 mm (length). Then, the non-aqueous electrolyte was injected into the pouch to manufacture a 2 Ah-class lithium secondary battery for an electric vehicle (EV). As the non-aqueous electrolyte, a solution in which LiPF₆ was dissolved at a concentration of 1 M in a mixed solvent containing ethylene carbonate and ethyl methyl carbonate in a volume ratio of 25:75 was used.

### Example 2

A lithium secondary battery was manufactured in the same manner as in Example 1, except that the cathode was fabricated such that the first cathode active material layer had an areal density of 8 mg/cm² and a thickness of 24 μm, and the second cathode active material layer had an areal density of 16 mg/cm² and a thickness of 46 μm.

### Example 3

A lithium secondary battery was manufactured in the same manner as in Example 1, except that the cathode was fabricated such that the first cathode active material layer had a thickness of 33 μm and the second cathode active material layer had a thickness of 33 μm.

### Example 4

A lithium secondary battery was manufactured in the same manner as in Example 1, except that NiSO₄, CoSO₄, and MnSO₄ were mixed in a ratio of 90:5:5 during the preparation of the cathode active material.

### Comparative Example 1

A lithium secondary battery was manufactured in the same manner as in Example 1, except that the second cathode active material layer was not formed.

### Comparative Example 2

A lithium secondary battery was manufactured in the same manner as in Example 1, except that the cathode was fabricated by uniformly applying the second cathode slurry onto an aluminum foil (thickness: 12 μm), followed by drying and roll-pressing to form a cathode active material layer having an areal density of 24 mg/cm² and a thickness of 70 μm.

### Comparative Example 3

A lithium secondary battery was manufactured in the same manner as in Example 2, except that, during the preparation of the cathode active material, a mixture containing lithium hydroxide and a transition metal precursor was introduced into a calcination furnace, heated to 930° C. to 950° C. at a heating rate of 2° C./min, and maintained at 930° C. to 950° C. for 15 hours to obtain second lithium metal oxide particles having a single particle structure of LiNi_{0.75}Co_{0.05}Mn_{0.2}O₂ (D₅₀: 5 μm).

### Comparative Example 4

A lithium secondary battery was manufactured in the same manner as in Example 1, except that the first cathode active material layer had a thickness of 33 μm and the second cathode active material layer had a thickness of 37 μm.

### Comparative Example 5

A lithium secondary battery was manufactured in the same manner as in Example 1, except that the first cathode active material layer had a thickness of 37 μm and the second cathode active material layer had a thickness of 33 μm.

### Experimental Example 1: Measurement of Pore Diameter and Porosity

Three-dimensional structure images representing the pore morphology of the cathode active material layers prepared in the examples and comparative examples were obtained using an X-ray microscope (XRM) (Xradia 520 Versa, manufactured by Zeiss). The median pore diameter (D50) and porosity of each cathode active material layer were measured based on the three-dimensional structure images.

TABLE 1

| | | | | | | | Ratio (first cathode | |
|---|---|---|---|---|---|---|---|---|
| | | | | | | | active material | |
| | First cathode active | | | Second cathode active | | | layer/second | |
| | material layer | | | material layer | | | cathode active | |
| | D50 | Porosity | Density | D50 | Porosity | Density | material layer) | |
| | (μm) | (%) | (g/cm³) | (μm) | (%) | (g/cm³) | D50 | Porosity |
| Example 1 | 14.47 | 25.8 | 3.43 | 4.53 | 14.0 | 3.43 | 3.19 | 1.85 |
| Example 2 | 14.12 | Unmeasured | 3.33 | 4.63 | Unmeasured | 3.48 | 3.05 | — |
| Example 3 | 12.5 | Unmeasured | 3.63 | 3.6 | Unmeasured | 3.63 | 3.47 | — |
| Example 4 | 14.5 | 24.8 | 3.43 | 4.3 | 13.0 | 3.43 | 3.37 | 1.91 |
| Comparative | 12.73 | 19.3 | 3.43 | — | — | — | — | — |
| Example 1 | | | | | | | | |
| Comparative | — | — | — | 4.91 | 20.6 | 3.43 | — | — |
| Example 2 | | | | | | | | |
| Comparative | 14.1 | Unmeasured | 3.43 | 5.8 | Unmeasured | 3.43 | 2.43 | — |
| Example 3 | | | | | | | | |
| Comparative | 12.4 | 21.9 | 3.63 | 5.9 | 13.0 | 3.24 | 2.10 | 1.68 |
| Example 4 | | | | | | | | |
| Comparative | 14.5 | 26.4 | 3.24 | 3.6 | 12.0 | 3.63 | 4.02 | 2.2 |
| Example 5 | | | | | | | | |

### Experimental Example 2: Evaluation of Capacity Retention Rate

The lithium secondary batteries of the examples and comparative examples were subjected to repeated charging from SOC 10% to SOC 80% at 25° C. for 20 minutes (4.2V CUT-OFF) and discharging to SOC 10% (1.0C constant current, 2.7V CUT-OFF) for 600 cycles. The capacity retention rate was calculated by dividing the discharge capacity at the 600th cycle by that at the 1st cycle and multiplying the result by 100.

### Experimental Example 3: Evaluation of High-Temperature Storage Characteristic

The lithium secondary batteries of the examples and comparative examples were charged to SOC 100% at 25° C. (0.5C CC/CV, 4.25V 0.05C CUT-OFF), and then left under ambient exposure conditions at 60° C. The time taken until venting occurred was measured.

TABLE 2

| | Capacity retention rate | Venting time |
|---|---|---|
| | (%) | (weeks) |
| Example 1 | 89.2 | 32 |
| Example 2 | 86.0 | 30 |
| Example 3 | 88.0 | 33 |
| Example 4 | 83.0 | 28 |
| Comparative Example 1 | 78.1 | 28 |
| Comparative Example 2 | 80.4 | 33 |
| Comparative Example 3 | 79.5 | 30 |
| Comparative Example 4 | 72.5 | 29 |
| Comparative Example 5 | 70.5 | 29 |

Referring to Table 1 above, in the cathodes of the examples, the ratio of the median pore diameter (D50) of the first cathode active material layer to that of the second cathode active material layer was 2.5 to 4.

Referring to Table 2 above, the capacity retention rate of the battery increased, thereby improving the cycle life characteristics. The battery was able to withstand long-term storage at high temperatures, and the lithium mobility in the active material remained high, thereby also enhancing the fast charging and discharging performance.

In contrast, in the batteries of the comparative examples, the ratio of the median pore diameter (D50) of the first cathode active material layer to that of the second cathode active material layer was less than 2.5 or greater than 4. As a result, the batteries of the comparative examples exhibited lower capacity retention rates than those of the examples, venting occurred more rapidly under high-temperature conditions, which degraded the high-temperature storage performance, and the charging and discharging rate of the batteries also decreased.

The contents described above are merely examples of applying the principles of the present disclosure, and other configurations may be further included without departing from the scope of the present disclosure.

### DESCRIPTION OF REFERENCE NUMERALS

100: Cathode
105: Cathode current collector
107: Cathode lead
110: Cathode active material layer
111: First cathode active material layer
112: Second cathode active material layer
120: Anode active material layer
125: Anode current collector
127: Anode lead
130: Anode
140: Separation membrane
150: Electrode assembly
160: Case

What is claimed is:

1. A cathode for a lithium secondary battery comprising:
a cathode current collector;
a first cathode active material layer disposed on at least one surface of the cathode current collector and comprising first lithium metal oxide particles having a secondary particle structure; and
a second cathode active material layer disposed on the first cathode active material layer and comprising second lithium metal oxide particles having a single particle structure,
wherein each of the first cathode active material layer and the second cathode active material layer includes pores, and
a ratio of a median pore diameter (D50) of the first cathode active material layer to that of the second cathode active material layer is 2.5 to 4.

2. The cathode for a lithium secondary battery according to claim 1, wherein a ratio of a porosity of the first cathode active material layer to that of the second cathode active material layer is greater than 1 and less than or equal to 5.

3. The cathode for a lithium secondary battery according to claim 1, wherein the first cathode active material layer has a median pore diameter (D50) of 10 μm to 20 μm.

4. The cathode for a lithium secondary battery according to claim 1, wherein the second cathode active material layer has a median pore diameter (D50) of 3 μm to 6 μm.

5. The cathode for a lithium secondary battery according to claim 1, wherein the first cathode active material layer has a porosity of 10% to 40%.

6. The cathode for a lithium secondary battery according to claim 1, wherein the second cathode active material layer has a porosity of 5% to 30%.

7. The cathode for a lithium secondary battery according to claim 1, wherein each of the first cathode active material layer and the second cathode active material layer independently has an areal density of 3 mg/cm² to 30 mg/cm².

8. The cathode for a lithium secondary battery according to claim 1, wherein each of the first cathode active material layer and the second cathode active material layer independently have a thickness of 10 μm to 100 μm.

9. The cathode for a lithium secondary battery according to claim 1, wherein a ratio of the density (g/cm³) of the first cathode active material layer to that of the second cathode active material layer is 0.3 to 1.1.

10. The cathode for a lithium secondary battery according to claim 1, wherein the first lithium metal oxide particles have a median particle diameter (D50) of 10 μm to 30 μm.

11. The cathode for a lithium secondary battery according to claim 1, wherein the second lithium metal oxide particles have a median particle diameter (D50) of 1 μm to 10 μm.

12. The cathode for a lithium secondary battery according to claim 1, wherein each of the first lithium metal oxide particles and the second lithium metal oxide particles includes nickel, and a mole fraction of nickel based on the total number of moles of elements excluding lithium and oxygen in the first lithium metal oxide particles and the second lithium metal oxide particles is 60 mol % to 99 mol %.

13. A lithium secondary battery comprising:
the cathode for a lithium secondary battery according to claim 1; and
an anode disposed opposite to the cathode.
